(19) United States
(12) Patent Application Publication
(10) Pub. No.: US 2024/0154179 A1
(43) Pub. Date: May 9, 2024

(54) ENERGY STORAGE DEVICE

(71) Applicant: GS Yuasa International Ltd., Kyoto-shi, Kyoto (JP)

(72) Inventors: Masumi OGAWA, Kyoto-shi, Kyoto (JP); Naoki OKADA, Kyoto-shi, Kyoto (JP)

(21) Appl. No.: 18/279,798

(22) PCT Filed: Feb. 8, 2022
(86) PCT No.: PCT/JP2022/004848

§ 371 Date: Aug. 31, 2023

(30) Foreign Application Priority Data
Mar. 2, 2021 (JP) 2021-032820

(51) Int. Cl. H01M 10/0587; H01M 10/0525; H01M 50/103; H01M 50/538

(52) U.S. Cl. CPC H01M 10/0587; H01M 10/0525; H01M 50/103; H01M 50/538

(57) ABSTRACT

An energy storage device includes: a first electrode assembly formed by winding a first plate; and a second electrode assembly formed by winding a second plate, in which the first electrode assembly includes a first positive electrode tab and a first negative electrode tab protruding from a part of a first electrode assembly body portion, the second electrode assembly includes a second positive electrode tab and a second negative electrode tab protruding from a part of a second electrode assembly body portion, the first electrode assembly body portion includes a first plate terminal end portion at a position facing the second electrode assembly body portion, the second electrode assembly body portion includes a second plate terminal end portion at a position facing the first electrode assembly body portion, and the first plate terminal end portion and the second plate terminal end portion are disposed at positions which do not overlap each other as viewed in an arrangement direction of the first electrode assembly and the second electrode assembly.

### TECHNICAL FIELD

The present invention relates to an energy storage device including a plurality of electrode assemblies formed by winding plates and including tabs.

### BACKGROUND ART

Conventionally, there has been known an energy storage device including a plurality of electrode assemblies formed by winding plates and including tabs. Patent Document 1 discloses a prismatic secondary battery (energy storage device) in which a positive electrode and a negative electrode are wound and which includes a plurality of flat wound groups (electrode assemblies) including tabs.

### PRIOR ART DOCUMENT

### Patent Document

Patent Document 1: WO 2017/141613 A

### SUMMARY OF THE INVENTION

### Problems to be Solved by the Invention

In an energy storage device in which an electrode assembly around which plates are wound is accommodated in a case, in general, the electrode assembly including the tabs as in the above-mentioned conventional energy storage device can have a larger occupying ratio of the electrode assembly in a case than an electrode assembly including no tab. For this reason, in the configuration including the electrode assembly including the tabs as in the above-mentioned conventional energy storage device, generally, the energy storage device can be reduced in size or increased in capacity. However, even in the configuration including the electrode assembly including the tabs as in the above-mentioned conventional energy storage device, when a plurality of electrode assemblies are disposed, an unnecessary space may be generated between the plurality of electrode assemblies. In such a case, there is a possibility of causing an increase in size or a decrease in capacity of the energy storage device, and the energy storage device cannot be reduced in size or increased in capacity.

The present invention has been made by the inventor of the present application focusing newly on the above problems, and an object of the present invention is to provide an energy storage device that can be reduced in size and increased in capacity.

### Means for Solving the Problems

An energy storage device according to one aspect of the present invention includes: a first electrode assembly formed by winding a first plate; and a second electrode assembly formed by winding a second plate, the first electrode assembly includes: a first electrode assembly body portion; and a first positive electrode tab and a first negative electrode tab which are tabs protruding from a part of the first electrode assembly body portion and disposed on a positive electrode side and a negative electrode side, the second electrode assembly includes: a second electrode assembly body portion; and a second positive electrode tab and a second negative electrode tab which are tabs protruding from a part of the second electrode assembly body portion and disposed on a positive electrode side and a negative electrode side, the first electrode assembly body portion includes a first plate terminal end portion which is a winding end portion of the first plate at a position facing the second electrode assembly body portion, the second electrode assembly body portion includes a second plate terminal end portion which is a winding end portion of the second plate at a position facing the first electrode assembly body portion, and the first plate terminal end portion and the second plate terminal end portion are disposed at positions which do not overlap each other as viewed in an arrangement direction of the first electrode assembly and the second electrode assembly.

The present invention can be realized not only as such an energy storage device but also as a combination of the first electrode assembly and the second electrode assembly.

### Advantages of the Invention

According to the energy storage device of the present invention, a reduction in size or an increase in capacity can be achieved.

### BRIEF DESCRIPTION OF THE DRAWINGS

FIG. 1 is a perspective view showing an external appearance of an energy storage device according to an embodiment.

FIG. 2 is an exploded perspective view showing respective components of the energy storage device according to the embodiment in an exploded manner.

FIG. 3 is a perspective view showing a configuration of a first electrode assembly and a second electrode assembly according to the embodiment.

FIG. 4 is a top view showing a configuration of the first electrode assembly according to the embodiment.

FIG. 5 is a top view showing a configuration of the second electrode assembly according to the embodiment.

FIG. 6 is a top view showing a positional relationship between the first electrode assembly and the second electrode assembly according to the embodiment.

FIG. 7 is a top view showing an example of arrangement positions of tabs of the first electrode assembly and the second electrode assembly according to Modification 1 of the embodiment.

FIG. 8 is a top view showing an example of arrangement positions of plate start end portions of the first electrode assembly and the second electrode assembly according to Modification 2 of the embodiment.

FIG. 9 is a top view showing an example of arrangement positions of plate start end portions and tabs of the first electrode assembly and the second electrode assembly according to Modification 3 of the embodiment.

### MODE FOR CARRYING OUT THE INVENTION

An energy storage device according to one aspect of the present invention includes: a first electrode assembly formed by winding a first plate; and a second electrode assembly formed by winding a second plate, the first electrode assembly includes: a first electrode assembly body portion; and a first positive electrode tab and a first negative electrode tab which are tabs protruding from a part of the first electrode assembly body portion and disposed on a positive electrode side and a negative electrode side, the second electrode assembly includes: a second electrode assembly body portion; and a second positive electrode tab and a second negative electrode tab which are tabs protruding from a part of the second electrode assembly body portion and disposed on a positive electrode side and a negative electrode side, the first electrode assembly body portion includes a first plate terminal end portion which is a winding end portion of the first plate at a position facing the second electrode assembly body portion, the second electrode assembly body portion includes a second plate terminal end portion which is a winding end portion of the second plate at a position facing the first electrode assembly body portion, and the first plate terminal end portion and the second plate terminal end portion are disposed at positions which do not overlap each other as viewed in an arrangement direction of the first electrode assembly and the second electrode assembly.

With such a configuration, in the energy storage device, the first electrode assembly around which the first plate is wound includes the first electrode assembly body portion, and the first positive electrode tab and the first negative electrode tab, and the second electrode assembly around which the second plate is wound includes the second electrode assembly body portion, and the second positive electrode tab and the second negative electrode tab. The first plate terminal end portion of the first electrode assembly body portion which faces the second electrode assembly body portion and the second plate terminal end portion of the second electrode assembly body portion which faces the first electrode assembly body portion are disposed at positions which do not overlap each other. In this manner, the first plate terminal end portion of the first electrode assembly body portion is disposed at a position facing the second electrode assembly body portion, and the second plate terminal end portion of the second electrode assembly body portion is disposed at a position facing the first electrode assembly body portion and at a position which does not overlap the first plate terminal end portion. With such a configuration, it is possible to suppress generation of an unnecessary space between the first electrode assembly and the second electrode assembly (between the first electrode assembly body portion and the second electrode assembly body portion) and hence, the energy storage device can be reduced in size or increased in capacity.

A direction from the first positive electrode tab toward the first negative electrode tab and a direction from the second positive electrode tab toward the second negative electrode tab may be the same direction.

The configuration in which the first plate terminal end portion of the first electrode assembly is disposed at a position facing the second electrode assembly body portion and the second plate terminal end portion of the second electrode assembly is disposed at a position facing the first electrode assembly body portion can be realized by rotating one of the two same electrode assemblies by 180°. However, in this case, the first positive electrode tab and the second positive electrode tab are disposed in opposite directions with respect to the first negative electrode tab and the second negative electrode tab, and it becomes difficult to connect tabs having the same polarity to one current collector. Therefore, even when the first plate terminal end portion and the second plate terminal end portion are disposed as described above, the direction from the first positive electrode tab toward the first negative electrode tab and the direction from the second positive electrode tab toward the second negative electrode tab are disposed in the same direction. Accordingly, since the first positive electrode tab and the second positive electrode tab are disposed in the same direction with respect to the first negative electrode tab and the second negative electrode tab, the tabs having the same polarity can be easily connected to one current collector.

At least one tab of the first positive electrode tab and the first negative electrode tab may be disposed so as to protrude from a part of a portion of the first electrode assembly body portion, the portion being on a side opposite to the second electrode assembly body portion with respect to a portion facing the second electrode assembly body portion, and a tab out of the second positive electrode tab and the second negative electrode tab, the tab having the same polarity as a polarity of the at least one tab may be disposed so as to protrude from a part of a portion of the second electrode assembly body portion, the portion being on a side opposite to the first electrode assembly body portion with respect to a portion facing the first electrode assembly body portion.

The configuration in which the first plate terminal end portion of the first electrode assembly is disposed at a position facing the second electrode assembly body portion and the second plate terminal end portion of the second electrode assembly is disposed at a position facing the first electrode assembly body portion can be realized by disposing the two same electrode assemblies in the same direction and adjusting the lengths of the plates. With such a configuration, it is possible to easily suppress generation of an unnecessary space between the first electrode assembly and the second electrode assembly (between the first electrode assembly body portion and the second electrode assembly body portion) and hence, the energy storage device can be easily reduced in size or increased in capacity. However, in this case, the tab of one of the first electrode assembly and the second electrode assembly is disposed at a portion facing the other electrode assembly. As a result, the distance between the tabs having the same polarity of the first electrode assembly and the second electrode assembly becomes short, and the tabs are densely disposed, so that an unnecessary space may be generated or it may be difficult to connect the tabs to the current collector. Accordingly, at least one tab of the first electrode assembly is disposed so as to protrude from a portion of the first electrode assembly body portion, the portion being on a side opposite to the second electrode assembly body portion, and the tab of the second electrode assembly, the tab having the same polarity as a polarity of the at least one tab of the first electrode assembly is disposed so as to protrude from a portion of the second electrode assembly body portion, the portion being on a side opposite to the first electrode assembly body portion. That is, the tabs having the same polarity of the first electrode assembly and the second electrode assembly are disposed on the sides opposite to the portions facing the electrode assembly body portions. With such a configuration, the tabs having the same polarity of the first electrode assembly and the second electrode assembly are disposed at positions spaced apart from each other and hence, it is possible to suppress generation of an unnecessary space due to dispersion of the tabs, and it is possible to make it easy to bend the tabs, whereby the tabs can be easily connected to the current collector.

At least one of the first electrode assembly body portion and the second electrode assembly body portion may include: a pair of curved portions formed by winding at least one of the first plate and the second plate; and a flat portion which connects the pair of curved portions, and at least one of the first plate terminal end portion and the second plate terminal end portion may be disposed on the flat portion.

With such a configuration, at least one of the first plate terminal end portion and the second plate terminal end portion is disposed on a flat portion of at least one of the first electrode assembly body portion and the second electrode assembly body portion. With such a configuration, a fixing position of the plate terminal end portion of the electrode assembly can be formed into a flat portion and hence, in the electrode assembly, the plate terminal end portion can be easily fixed with a tape or the like. When the flat portions are formed on both the first electrode assembly body portion and the second electrode assembly body portion, the plate terminal end portion can be sandwiched between the flat portions of both the first electrode assembly body portion and the second electrode assembly body portion and hence, the plate terminal end portion can be easily fixed.

The first plate terminal end portion may extend toward the second plate terminal end portion at a portion of the first electrode assembly body portion, the portion facing the second electrode assembly body portion, and the second plate terminal end portion may extend toward the first plate terminal end portion at a portion of the second electrode assembly body portion, the portion facing the first electrode assembly body portion.

With such a configuration, both the first plate terminal end portion and the second plate terminal end portion are disposed so as to extend toward each other in the first electrode assembly body portion and the second electrode assembly body portion and hence, the total lengths of both the first plate and the second plate can be increased. With such a configuration, a space between the first electrode assembly and the second electrode assembly can be effectively utilized and hence, the first electrode assembly and the second electrode assembly can be increased in capacity, whereby the energy storage device can be reduced in size or increased in capacity.

The first electrode assembly body portion may further include a first plate start end portion which is a winding start portion of the first plate, the second electrode assembly body portion may further include a second plate start end portion which is a winding start portion of the second plate, and the first plate start end portion and the second plate start end portion may protrude in directions facing each other and may be disposed at positions which do not overlap each other as viewed from an arrangement direction of the first electrode assembly and the second electrode assembly.

With such a configuration, the first plate start end portion of the first electrode assembly body portion and the second plate start end portion of the second electrode assembly body portion are disposed at positions which do not overlap each other as viewed in the arrangement direction of the first electrode assembly and the second electrode assembly. With such a configuration, an overlap between the first plate and the second plate can be reduced and hence, the energy storage device can be reduced in size or increased in capacity.

Hereinafter, an energy storage device according to an embodiment of the present invention (including modifications thereof) will be described with reference to the drawings. The embodiment described below describes a comprehensive or specific example. The numerical values, shapes, materials, components, positions for arranging the components and connection forms of the components, manufacturing processes, the order of the manufacturing processes, and the like described in the following embodiment are merely examples, and are not intended to limit the present invention. In each drawing, dimensions and the like are not strictly shown. In each drawing, the same or similar components are denoted by the same reference numerals.

In the following description and drawings, an arrangement direction of a pair of (positive electrode side and negative electrode side, the same applies hereinafter) electrode terminals included in an energy storage device, an arrangement direction of a pair of current collectors, a width direction of a first electrode assembly and a second electrode assembly, or a facing direction of short side surfaces of a case is defined as an X-axis direction. An arrangement direction of the first electrode assembly and the second electrode assembly, a layering direction of plates of the first electrode assembly and the second electrode assembly, a thickness direction of the first electrode assembly and the second electrode assembly, a facing direction of long side surfaces of the case, or a thickness direction of the case is defined as a Y-axis direction. An extending direction of the winding axis of the first electrode assembly and the winding axis of the second electrode assembly, a height direction of the first electrode assembly and the second electrode assembly, an arrangement direction of the electrode terminal, the current collector, the first electrode assembly, and the second electrode assembly, an arrangement direction of a case body and a lid body of the case, or a vertical direction is defined as a Z-axis direction. The X-axis direction, the Y-axis direction, and the Z-axis direction are directions intersecting (orthogonal in the present embodiment) with each other. Although it is considered that the Z-axis direction may not be the vertical direction depending on the usage mode, the Z-axis direction will be described below as the vertical direction for convenience of description.

In the following description, the X-axis positive direction indicates an arrow direction of the X axis, and the X-axis negative direction indicates a direction opposite to the X-axis positive direction. The same applies to the Y-axis direction and the Z-axis direction. Expressions indicating relative directions or postures, such as parallel and orthogonal include cases of being not strictly the directions or postures. Two directions being orthogonal to each other not only means that the two directions are completely orthogonal to each other, but also means that the two directions are substantially orthogonal to each other, that is, a difference of about several percent is allowed.

### Embodiment

### [1 General Description of Energy Storage Device 10]

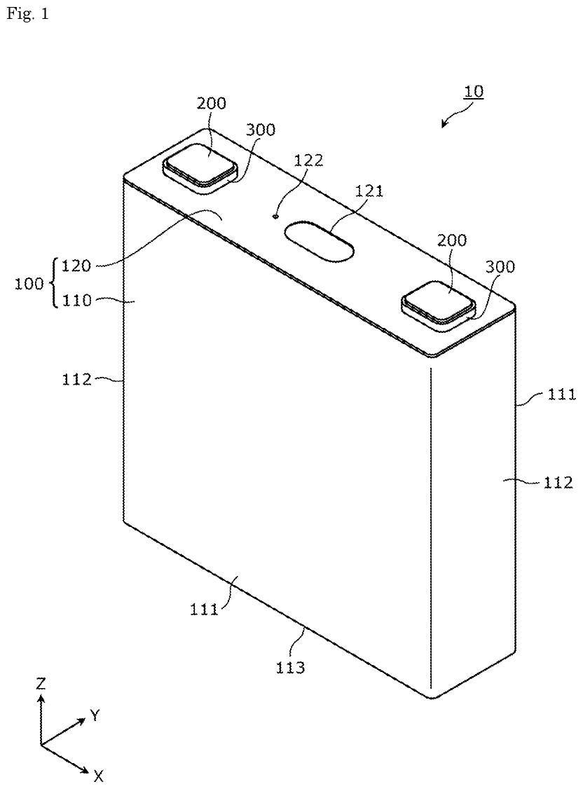

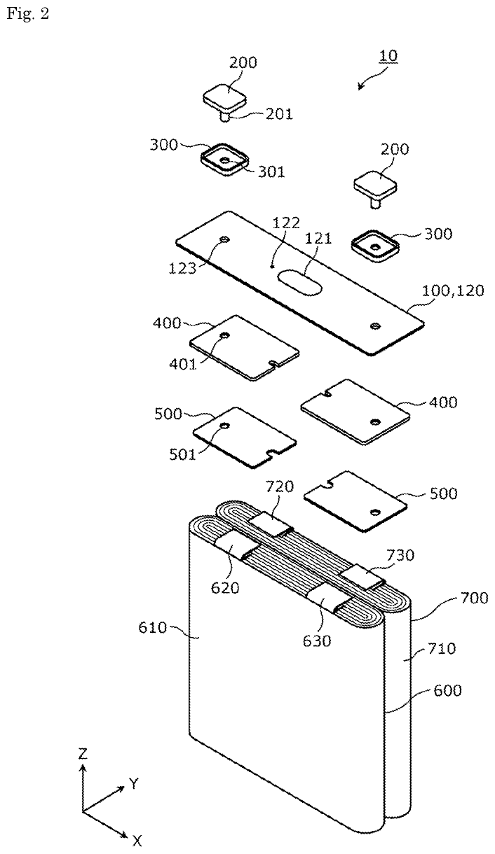

First, an energy storage device 10 according to the present embodiment will be generally described. FIG. 1 is a perspective view showing an external appearance of an energy storage device 10 according to the present embodiment. FIG. 2 is an exploded perspective view showing respective components of the energy storage device 10 according to the present embodiment in an exploded manner. In FIG. 2, among the respective components included in the energy storage device 10, a case body 110 of the case 100 is not shown.

The energy storage device 10 is a secondary battery (battery cell) capable of charging and discharging electricity, and is specifically a nonaqueous electrolyte secondary battery such as a lithium ion secondary battery. The energy storage device 10 is used for power storage applications, power supply applications, or the like. The energy storage device 10 is used as a battery or the like for driving or starting an engine of a moving body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and a gasoline vehicle. Examples of the railway vehicle for an electric railway include a train, a monorail, a linear motor car, and a hybrid train including both a diesel engine and an electric motor. The energy storage device 10 can also be used as a stationary battery or the like used for home use, business use, or the like.

The energy storage device 10 is not limited to the nonaqueous electrolyte secondary battery, and may be a secondary battery other than the nonaqueous electrolyte secondary battery, or may be a capacitor. The energy storage device 10 may be not a secondary battery but a primary battery that can use stored electricity unless being charged by a user. The energy storage device 10 may be a battery using a solid electrolyte. The energy storage device 10 may be a pouch type energy storage device. In the present embodiment, the energy storage device 10 having a flat rectangular parallelepiped shape (prismatic shape) is shown, but the shape of the energy storage device 10 is not limited to the rectangular parallelepiped shape, and may be a cylindrical shape, an oval columnar shape, a polygonal columnar shape other than a rectangular parallelepiped, or the like.

As shown in FIG. 1, the energy storage device 10 includes the case 100 (the case body 110 and a lid body 120), a pair of (positive electrode side and negative electrode side) electrode terminals 200, and a pair of (positive electrode side and negative electrode side) upper gaskets 300. As shown in FIG. 2, a pair of (positive electrode side and negative electrode side) lower gaskets 400, a pair of (positive electrode side and negative electrode side) current collectors 500, a first electrode assembly 600, and a second electrode assembly 700 are accommodated in the case 100 (case body 110). Although an electrolyte solution (nonaqueous electrolyte) is sealed in the case 100, the illustration is omitted. A type of the electrolyte solution is not particularly limited as long as performance of the energy storage device 10 is not impaired, and various types of electrolyte solutions can be selected. In addition to the above components, a spacer disposed on a side, a lower side, or the like of the first electrode assembly 600 and the second electrode assembly 700, an insulating tape for fixing (binding) the first electrode assembly 600 and the second electrode assembly 700, an insulating film for enclosing the first electrode assembly 600, the second electrode assembly 700, and the like may be disposed.

The case 100 is a case having a rectangular parallelepiped shape (prismatic shape or box shape) including the case body 110 in which an opening is formed and the lid body 120 that closes the opening of the case body 110. The case body 110 is a member having a rectangular cylindrical shape, including a bottom and constituting a body portion of the case 100. The case body 110 includes a pair of flat plate-shaped and rectangular long side wall portions 111 on side surfaces (long side surfaces) on both sides in the Y-axis direction, a pair of flat plate-shaped and rectangular short side wall portions 112 on side surfaces (short side surfaces) on both sides in the X-axis direction, and a flat plate-shaped and rectangular bottom wall portion 113 on the Z-axis negative direction side. The lid body 120 is a rectangular plate-shaped member which forms a lid portion of the case 100 and extends in the X-axis direction, and is disposed in the Z-axis positive direction of the case body 110. The lid body 120 is provided with a gas release valve 121 that releases the pressure when the pressure inside the case 100 excessively increases, an electrolyte solution filling portion 122 for filling an electrolyte solution into the case 100, and the like.

With such a configuration, the case 100 has a structure in which the inside is sealed by joining the case body 110 and the lid body 120 by welding or the like after the first electrode assembly 600, the second electrode assembly 700, and the like are accommodated in the case body 110. The material of the case 100 (the case body 110 and the lid body 120) is not particularly limited, and for example, weldable metal such as stainless steel, aluminum, an aluminum alloy, iron, or a plated steel plate can be used, but resin can also be used.

Each of the first electrode assembly 600 and the second electrode assembly 700 is an energy storage element (power generating element) which includes a positive electrode plate, a negative electrode plate, and a separator, and can store electricity. To be more specific, each of the first electrode assembly 600 and the second electrode assembly 700 is a so-called laterally wound electrode assembly which is formed by winding a positive electrode plate and a negative electrode plate with a separator sandwiched therebetween, which are disposed in a layered manner, and has an oval shape as viewed in the Z-axis direction.

Specifically, in the first electrode assembly 600, a plurality of tabs of the positive electrode plate are layered to form a first positive electrode tab 620 which is a tab bundle on the positive electrode side, and a plurality of tabs of the negative electrode plate are layered to form a first negative electrode tab 630 which is a tab bundle on the negative electrode side. That is, the first electrode assembly 600 includes the first electrode assembly body portion 610 and the first positive electrode tab 620 and the first negative electrode tab 630 which are tabs which protrude from a part of the first electrode assembly body portion 610 in the Z-axis positive direction and are tabs on the positive electrode side and the negative electrode side. Similarly, in the second electrode assembly 700, a plurality of tabs of the positive electrode plate are layered to form a second positive electrode tab 720 which is a tab bundle on the positive electrode side, and a plurality of tabs of the negative electrode plate are layered to form a second negative electrode tab 730 which is a tab bundle on the negative electrode side. That is, the second electrode assembly 700 includes the second electrode assembly body portion 710 and the second positive electrode tab 720 and the second negative electrode tab 730 which are tabs which protrude from a part of the second electrode assembly body portion 710 in the Z-axis positive direction and are tabs on the positive electrode side and the negative electrode side. The configurations of the first electrode assembly 600 and the second electrode assembly 700 will be described in detail later.

The electrode terminals 200 are terminal members (a positive electrode terminal and a negative electrode terminal) electrically connected to the first electrode assembly 600 and the second electrode assembly 700 through the current collectors 500. That is, the electrode terminals 200 are members made of metal for leading out electricity stored in the first electrode assembly 600 and the second electrode assembly 700 to an external space of the energy storage device 10, and for introducing electricity into a space inside the energy storage device 10 so as to store electricity in the first electrode assembly 600 and the second electrode assembly 700. The electrode terminal 200 is formed of a conductive member made of metal such as aluminum, an aluminum alloy, copper, or a copper alloy. The electrode terminal 200 is connected (joined) to the current collector 500 by caulking or the like, and is attached to the lid body 120.

To be more specific, the electrode terminal 200 includes a shaft portion 201 (rivet portion) which extends downward (in the Z-axis negative direction). The shaft portion 201 is inserted and caulked into a through hole 301 of the upper gasket 300, a through hole 123 of the lid body 120, a through hole 401 of the lower gasket 400, and a through hole 501 of the current collector 500. Accordingly, the electrode terminal 200 is fixed to the lid body 120 together with the upper gasket 300, the lower gasket 400, and the current collector 500. The method of connecting (joining) the electrode terminal 200 and the current collector 500 is not limited to caulking, and welding such as ultrasonic welding, laser welding, or resistance welding, or mechanical joining other than caulking such as screw fastening may be used.

The current collectors 500 are flat plate-shaped and rectangular current collecting members (a positive electrode current collector and a negative electrode current collector) which electrically connect the first electrode assembly 600 and the second electrode assembly 700 to the electrode terminal 200. Specifically, the current collector 500 on the positive electrode side is connected (joined) to the first positive electrode tab 620 of the first electrode assembly 600 and the second positive electrode tab 720 of the second electrode assembly 700 by welding or the like, and is joined to the electrode terminal 200 on the positive electrode side by caulking or the like as described above. The current collector 500 on the negative electrode side is connected (joined) to the first negative electrode tab 630 of the first electrode assembly 600 and the second negative electrode tab 730 of the second electrode assembly 700 by welding or the like, and is joined to the electrode terminal 200 on the negative electrode side by caulking or the like as described above.

The material of the current collector 500 is not particularly limited, but the current collector 500 on the positive electrode side is formed of a conductive member such as metal such as aluminum or an aluminum alloy, and the current collector 500 on the negative electrode side is formed of a conductive member such as metal such as copper or a copper alloy. As a method of connecting (joining) the current collector 500 to the first positive electrode tab 620 and the second positive electrode tab 720 or the first negative electrode tab 630 and the second negative electrode tab 730, any welding such as ultrasonic welding, laser welding, or resistance welding may be used, or mechanical joining such as caulking joining or screw fastening may be used.

The upper gasket 300 is a flat plate-shaped electrically insulating sealing member disposed between the lid body 120 of the case 100 and the electrode terminal 200. The lower gasket 400 is a flat plate-shaped electrically insulating sealing member disposed between the lid body 120 and the current collector 500. The upper gasket 300 and the lower gasket 400 are made of an electrically insulating resin such as polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), an ABS resin, or a composite material thereof.

### [2 Description of Configurations of First Electrode Assembly 600 and Second Electrode Assembly 700]

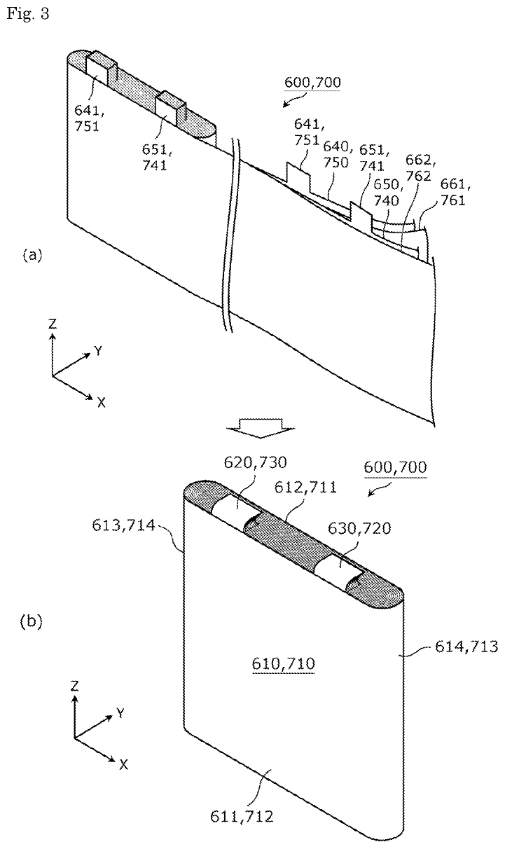

Next, the configurations of the first electrode assembly 600 and the second electrode assembly 700 will be described in detail. FIG. 3 is a perspective view showing configurations of the first electrode assembly 600 and the second electrode assembly 700 according to the present embodiment. Since the first electrode assembly 600 and the second electrode assembly 700 have the same configuration, in FIG. 3, the configurations of the first electrode assembly 600 and the second electrode assembly 700 are shown using the same view. Specifically, FIG. 3(a) shows a configuration in a state where a wound state of the first electrode assembly 600 (or the second electrode assembly 700) is partially developed, and FIG. 3(b) shows a configuration of the first electrode assembly 600 (or the second electrode assembly 700) after winding.

Since the first electrode assembly 600 and the second electrode assembly 700 have the same configuration as described above, the configuration of the first electrode assembly 600 will be mainly described below, and the description of the configuration of the second electrode assembly 700 will be simplified or omitted. As shown in FIG. 3(a), the first electrode assembly 600 includes first plates 640 and 650 and first separators 661 and 662, and is formed by alternately layering and winding the first plates 640 and 650 and the first separators 661 and 662. In the present embodiment, the first plate 640 is a positive electrode plate, and the first plate 650 is a negative electrode plate. That is, the first electrode assembly 600 is formed by layering and winding the first plate 640 on the positive electrode side, the first separator 661, the first plate 650 on the negative electrode side, and the first separator 662 in this order. In the present embodiment, when the first plates 640 and 650 are wound, the first plate 650 on the negative electrode side is disposed on the innermost circumference (innermost layer) and the outermost circumference (outermost layer) of the first plates 640 and 650.

The first plate 640 on the positive electrode side is a plate (electrode plate) in which a positive active material layer is formed on a surface of a positive electrode substrate layer which is an elongated strip-shaped metal foil made of aluminum, an aluminum alloy, or the like. The first plate 650 on the negative electrode side is a plate (electrode plate) in which a negative active material layer is formed on a surface of a negative electrode substrate layer which is an elongated strip-shaped metal foil made of copper, a copper alloy, or the like. As the positive electrode substrate layer and the negative electrode substrate layer, known materials such as nickel, iron, stainless steel, titanium, fired carbon, a conductive polymer, a conductive glass, and an Al—Cd alloy can be appropriately used as long as the materials are stable against an oxidation-reduction reaction during charging and discharging. As the positive active material used for the positive active material layer and the negative electrode active material used for the negative active material layer, known materials can be appropriately used as long as they are a positive active material and a negative electrode active material capable of occluding and releasing lithium ions.

A polyanion compound such as LiMPO₄, LiMSiO₄, or LiMBO₃ (M represents one or more transition metal elements selected from Fe, Ni, Mn, Co, and the like), lithium titanate, a spinel type lithium manganese oxide such as LiMn₂O₄ or LiMn_{1.5}Ni_{0.5}O₄, a lithium transition metal oxide such as LiMO₂ (M represents one or more transition metal elements selected from Fe, Ni, Mn, Co, and the like), or the like can be used as the positive active material. Examples of the negative active material include lithium metal, a lithium alloy (lithium metal-containing alloys such as lithium-silicon, lithium-aluminum, lithium-lead, lithium-tin, lithium-aluminum-tin, lithium-gallium, and Wood's alloy), an alloy capable of occluding and releasing lithium, a carbon material (for example, graphite, non-graphitizable carbon, graphitizable carbon, low-temperature baked carbon, amorphous carbon, and the like), a silicon oxide, a metal oxide, a lithium metal oxide (Li₄Ti₅O₁₂ or the like), a polyphosphoric acid compound, and a compound of a transition metal and a group 14 element to a group 16 element, such as Co₃O₄ or Fe₂P, which is generally called a conversion negative electrode.

The first separators 661 and 662 are microporous sheets made of resin. As a material of the first separators 661 and 662, a known material can be appropriately used as long as the performance of the energy storage device 10 is not impaired. As the first separators 661 and 662, a woven fabric insoluble in an organic solvent, a nonwoven fabric, a synthetic resin microporous membrane made of a polyolefin resin such as polyethylene, or the like can be used.

The first plate 640 includes a plurality of rectangular tabs 641 protruding in the Z-axis positive direction at an end portion in the Z-axis positive direction, and the plurality of tabs 641 are disposed in a state of being layered in the Y-axis direction. Similarly, the first plate 650 includes a plurality of rectangular tabs 651 protruding in the Z-axis positive direction at an end portion in the Z-axis positive direction, and the plurality of tabs 651 are disposed in a state of being layered in the Y-axis direction. The tabs 641 and 651 are portions where the active material layer is not formed and the substrate layer is exposed. The shapes of the tabs 641 and 651 are not particularly limited.

As shown in FIG. 3(b), the plurality of layered tabs 641 are bundled to form the first positive electrode tab 620 extending in a state of protruding in the Z-axis positive direction. Similarly, the plurality of layered tabs 651 are bundled to form the first negative electrode tab 630 extending in a state of protruding in the Z-axis positive direction. In the present embodiment, the first positive electrode tab 620 and the first negative electrode tab 630 are disposed so as to protrude in the Z-axis positive direction from a part of a first electrode assembly flat portion 611 described later. The first positive electrode tab 620 and the first negative electrode tab 630 are each joined to a surface in the Y-axis positive direction of the current collector 500 opposed to the first positive electrode tab 620 and the first negative electrode tab 630 in the Y-axis direction, and are each then bent together with the current collector 500 in the Y-axis positive direction.

The first electrode assembly body portion 610 is a portion which forms a body of the first electrode assembly 600, and specifically, is a portion of the first electrode assembly 600 other than the first positive electrode tab 620 and the first negative electrode tab 630. That is, the first electrode assembly body portion 610 is an elongated cylindrical portion or an elongated columnar portion which is formed by winding portions of the first plates 640 and 650 where the active material layers are formed and the first separators 661 and 662. As a result, the first electrode assembly body portion 610 includes a pair of first electrode assembly flat portions 611 and 612 on both sides in the Y-axis direction, and includes a pair of first electrode assembly curved portions 613 and 614 on both sides in the X-axis direction.

The first electrode assembly flat portion 611 is a portion which has a flat and rectangular shape extending parallel to the XZ plane directed in the Y-axis negative direction and connects the pair of first electrode assembly curved portions 613 and 614, and is disposed to face the long side wall portion 111 of the case body 110 in the Y-axis negative direction. The first electrode assembly flat portion 612 is a portion which has a flat and rectangular shape extending parallel to the XZ plane directed in the Y-axis positive direction and connects the pair of first electrode assembly curved portions 613 and 614, and is disposed to face the second electrode assembly 700. The first electrode assembly curved portion 613 is a curved portion which is curved in a semicircular arc shape so as to protrude in the X-axis negative direction as viewed in the Z-axis direction and extends in the Z-axis direction, and is disposed to face the short side wall portion 112 of the case body 110 in the X-axis negative direction. The first electrode assembly curved portion 614 is a curved portion which is curved in a semicircular arc shape so as to protrude in the X-axis positive direction as viewed in the Z-axis direction and extends in the Z-axis direction, and is disposed to face the short side wall portion 112 of the case body 110 in the X-axis positive direction.

Similarly, the second electrode assembly 700 includes second plates 740 and 750 and second separators 761 and 762, and is formed by alternately layering and winding the second plates 740 and 750 and the second separators 761 and 762. In the present embodiment, the second plate 740 is a positive electrode plate, and the second plate 750 is a negative electrode plate. The second plate 740 includes tabs 741, and the second plate 750 includes tabs 751. The plurality of tabs 741 are bundled to form the second positive electrode tab 720, and the plurality of tabs 751 are bundled to form the second negative electrode tab 730.

In the present embodiment, the second positive electrode tab 720 is disposed at a position corresponding to the first negative electrode tab 630, and the second negative electrode tab 730 is disposed at a position corresponding to the first positive electrode tab 620. That is, the second positive electrode tab 720 and the second negative electrode tab 730 are disposed at positions opposite to the positions of the first positive electrode tab 620 and the first negative electrode tab 630. In other words, the second plate 740 includes the tabs 741 at positions corresponding to the tabs 651 of the first plate 650, and the second plate 750 includes the tabs 751 at positions corresponding to the tabs 641 of the first plate 640. It can also be said that the second plate 740 is disposed at a position corresponding to the first plate 650, and the second plate 750 is disposed at a position corresponding to the first plate 640 (the arrangement positions of the positive electrode plates and the negative electrode plates of the first electrode assembly 600 and the second electrode assembly 700 are reversed). However, similarly to the first plate 650, when the second plates 740 and 750 are wound, the second plate 750 on the negative electrode side is disposed on the innermost circumference (innermost layer) and the outermost circumference (outermost layer) of the second plates 740 and 750. In FIG. 3, the second electrode assembly 700 is shown such that the layering order of the positive electrode plate and the negative electrode plate is reversed from that of the first electrode assembly 600, but the positive electrode plate and the negative electrode plate may be wound in the same layering order as the first electrode assembly 600 by reversing the positions of the tabs of the positive electrode plate and the negative electrode plate from those of the first electrode assembly 600.

The second electrode assembly body portion 710 of the second electrode assembly 700 includes a pair of second electrode assembly flat portions 711 and 712 on both sides in the Y-axis direction and a pair of second electrode assembly curved portions 713 and 714 on both sides in the X-axis direction. In the present embodiment, the second electrode assembly flat portion 711 is disposed at a position corresponding to the first electrode assembly flat portion 612 of the first electrode assembly 600, and the second electrode assembly flat portion 712 is disposed at a position corresponding to the first electrode assembly flat portion 611 of the first electrode assembly 600. That is, the second positive electrode tab 720 and the second negative electrode tab 730 are disposed so as to protrude from a part of the second electrode assembly flat portion 712 in the Z-axis positive direction. The second electrode assembly curved portion 713 is disposed at a position corresponding to the first electrode assembly curved portion 614 of the first electrode assembly 600, and the second electrode assembly curved portion 714 is disposed at a position corresponding to the first electrode assembly curved portion 613 of the first electrode assembly 600.

As shown in FIG. 2, the second electrode assembly 700 is disposed in a posture rotated by 180° about the Z axis from the state shown in FIG. 3(b) in the Y-axis positive direction of the first electrode assembly 600. With such a configuration, the second electrode assembly flat portion 711 is disposed to face the first electrode assembly 600 in a state where the second electrode assembly flat portion 711 is directed in the Y-axis negative direction. The second electrode assembly flat portion 712 is disposed to face the long side wall portion 111 of the case body 110 in the Y-axis positive direction in a state where the second electrode assembly flat portion 712 faces the Y-axis positive direction. The second electrode assembly curved portion 713 is disposed to face the short side wall portion 112 of the case body 110 in the X-axis negative direction so as to protrude in the X-axis negative direction. The second electrode assembly curved portion 714 is disposed to face the short side wall portion 112 of the case body 110 in the X-axis positive direction so as to protrude in the X-axis positive direction.

As described above, at least one of the first electrode assembly body portion 610 and the second electrode assembly body portion 710 includes a pair of curved portions formed by winding at least one of the first plates 640 and 650 and the second plates 740 and 750 and flat portions which connect the pair of curved portions. In the present embodiment, both the first electrode assembly body portion 610 and the second electrode assembly body portion 710 have a pair of curved portions formed by winding the first plates 640 and 650 and the second plates 740 and 750, and flat portions which connect the pair of curved portions.

### [3 Description of Details and Positional Relationship of First Electrode Assembly 600 and Second Electrode Assembly 700]

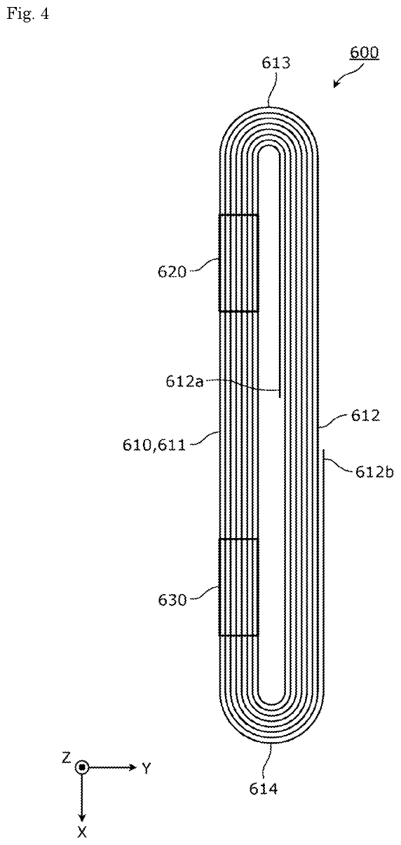

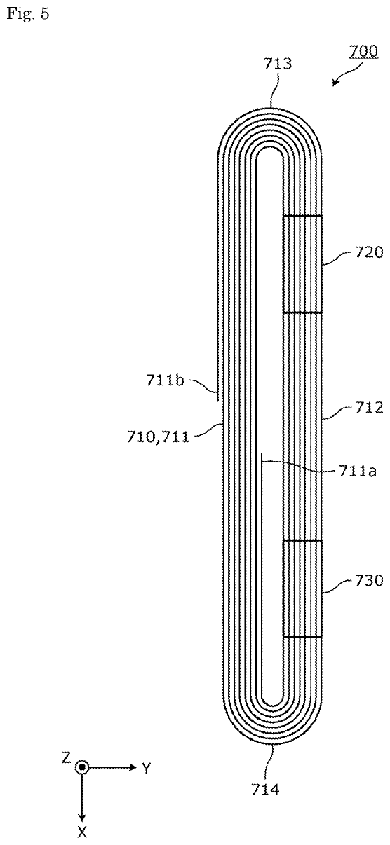

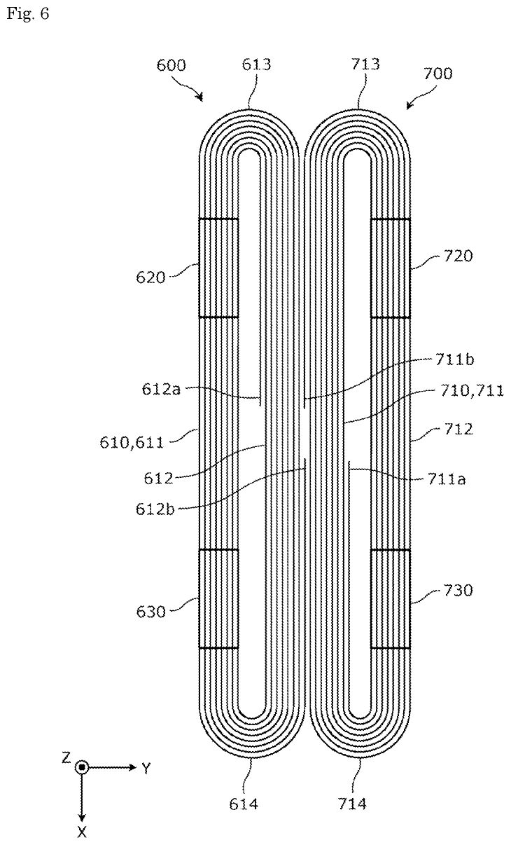

Next, the first electrode assembly 600 and the second electrode assembly 700 will be described in more detail, and a positional relationship therebetween will be described. FIG. 4 is a top view showing a configuration of the first electrode assembly 600 according to the present embodiment. FIG. 5 is a top view showing a configuration of the second electrode assembly 700 according to the present embodiment. FIG. 6 is a top view showing the positional relationship between the first electrode assembly 600 and the second electrode assembly 700 according to the present embodiment. Specifically, FIGS. 4 and 5 are views of the first electrode assembly 600 and the second electrode assembly 700 as viewed from the Z-axis positive direction, and FIG. 6 is a view of a configuration in a case where the first electrode assembly 600 shown in FIG. 4 and the second electrode assembly 700 shown in FIG. 5 are assembled as viewed from the Z-axis positive direction.

In the first electrode assembly 600, since the first plates 640 and 650 are wound together, the first plate 650 on the negative electrode side is slightly longer in the winding direction than the first plate 640 on the positive electrode side, but has substantially the same shape as viewed from the Z-axis positive direction. For this reason, for convenience of description, in FIGS. 4 and 6, one of the first plates 640 and 650 (for example, the first plate 640) of the first electrode assembly 600 and the first separators 661 and 662 are not shown, and a state where the other electrode plate (for example, the first plate 650) is wound is shown. Similarly, with respect to the second electrode assembly 700, in FIGS. 5 and 6, illustration of one of the second plates 740 and 750 (for example, the second plate 740) and the second separators 761 and 762 is omitted, and a state where the other electrode plate (for example, the second plate 750) is wound is shown. FIGS. 4 to 6 show simplified views in which the number of windings of the first plate 650 (or 640) and the number of windings of the second plate 750 (or 740) are reduced.

As shown in FIG. 4, in the first electrode assembly 600, the first electrode assembly body portion 610 includes a first plate start end portion 612a and a first plate terminal end portion 612b. The first plate start end portion 612a is a winding start portion of the first plate 650 (or 640), and is disposed at an end portion of the first electrode assembly flat portion 612 in the Y-axis negative direction and at a middle portion of the first electrode assembly flat portion 612 in the X-axis direction in the present embodiment. The first plate start end portion 612a is a distal end portion of the electrode plate which is disposed on the innermost circumference (innermost layer) of the first plate 650 (or 640) and extends in the X-axis positive direction from the first electrode assembly curved portion 613.

The first plate terminal end portion 612b is a winding end portion of the first plate 650 (or 640), and is disposed at an end portion of the first electrode assembly flat portion 612 in the Y-axis positive direction and at a middle portion of the first electrode assembly flat portion 612 in the X-axis direction in the present embodiment. The first plate terminal end portion 612b is a distal end portion of the electrode plate which is disposed on the outermost circumference (outermost layer) of the first plate 650 (or 640) and extends in the X-axis negative direction from the first electrode assembly curved portion 614. The first plate terminal end portion 612b is disposed in the X-axis positive direction with respect to the first plate start end portion 612a. That is, the first plate terminal end portion 612b is disposed at a position which does not overlap the first plate start end portion 612a as viewed in the Y-axis direction.

As shown in FIG. 5, in the second electrode assembly 700, the second electrode assembly body portion 710 includes a second plate start end portion 711a and a second plate terminal end portion 711b. The second plate start end portion 711a is a winding start portion of the second plate 750 (or 740), and is disposed at an end portion of the second electrode assembly flat portion 711 in the Y-axis positive direction and at a middle portion of the second electrode assembly flat portion 711 in the X-axis direction in the present embodiment. The second plate start end portion 711a is a distal end portion of the electrode plate which is disposed on the innermost circumference (innermost layer) of the second plate 750 (or 740) and extends in the X-axis negative direction from the second electrode assembly curved portion 714.

The second plate terminal end portion 711b is a winding end portion of the second plate 750 (or 740), and is disposed at an end portion of the second electrode assembly flat portion 711 in the Y-axis negative direction and at a middle portion of the second electrode assembly flat portion 711 in the X-axis direction in the present embodiment. The second plate terminal end portion 711b is a distal end portion of the electrode plate which is disposed on the outermost circumference (outermost layer) of the second plate 750 (or 740) and extends in the X-axis positive direction from the second electrode assembly curved portion 713. The second plate terminal end portion 711b is disposed in the X-axis negative direction with respect to the second plate start end portion 711a. That is, the second plate terminal end portion 711b is disposed at a position which does not overlap the second plate start end portion 711a as viewed in the Y-axis direction.

As described above, at least one of the first plate terminal end portion 612b and the second plate terminal end portion 711b is disposed on the flat portion of the electrode assembly body portion. In the present embodiment, both the first plate terminal end portion 612b and the second plate terminal end portion 711b are disposed on the flat portions (the first electrode assembly flat portion 612 and the second electrode assembly flat portion 711) of the electrode assembly body portion. Similarly, at least one of the first plate start end portion 612a and the second plate start end portion 711a is disposed on the flat portion of the electrode assembly body portion. In the present embodiment, both the first plate start end portion 612a and the second plate start end portion 711a are disposed on the flat portions (the first electrode assembly flat portion 612 and the second electrode assembly flat portion 711) of the electrode assembly body portion.

In the above-mentioned configuration, as shown in FIG. 6, the first plate terminal end portion 612b of the first electrode assembly 600 is disposed at a position which faces the second electrode assembly body portion 710 of the second electrode assembly 700 (a position which faces the second electrode assembly flat portion 711). To be more specific, the first plate terminal end portion 612b extends to a middle portion of a portion of the first electrode assembly body portion 610 which faces the second electrode assembly body portion 710. Since the portion of the first electrode assembly body portion 610 which faces the second electrode assembly body portion 710 is formed of the first electrode assembly flat portion 612, the first plate terminal end portion 612b extends to the middle portion of the first electrode assembly flat portion 612 in the X-axis direction.

The second plate terminal end portion 711b of the second electrode assembly 700 is disposed at a position facing the first electrode assembly body portion 610 of the first electrode assembly 600 (a position facing the first electrode assembly flat portion 612). To be more specific, the second plate terminal end portion 711b extends to a middle portion of a portion of the second electrode assembly body portion 710 which faces the first electrode assembly body portion 610. Since the portion of the second electrode assembly body portion 710 which faces the first electrode assembly body portion 610 is formed of the second electrode assembly flat portion 711, the second plate terminal end portion 711b extends to the middle portion of the second electrode assembly flat portion 711 in the X-axis direction.

With such a configuration, the first plate terminal end portion 612b and the second plate terminal end portion 711b are disposed so as to face each other with their distal ends facing each other in the X-axis direction. That is, the first plate terminal end portion 612b and the second plate terminal end portion 711b are disposed so as to protrude in directions facing each other as viewed in the arrangement direction of the first electrode assembly 600 and the second electrode assembly 700 (Y-axis direction). In other words, the first plate terminal end portion 612b extends toward the second plate terminal end portion 711b at a portion of the first electrode assembly body portion 610 which faces the second electrode assembly body portion 710. The second plate terminal end portion 711b extends toward the first plate terminal end portion 612b at a portion of the second electrode assembly body portion 710 which faces the first electrode assembly body portion 610. The first plate terminal end portion 612b and the second plate terminal end portion 711b are disposed at positions which do not overlap each other as viewed in the arrangement direction of the first electrode assembly 600 and the second electrode assembly 700 (Y-axis direction). In the present embodiment, the first plate terminal end portion 612b and the second plate terminal end portion 711b are disposed at an interval in the X-axis direction as viewed in the Y-axis direction, but may be disposed so as not to be spaced apart from each other in the X-axis direction. Specifically, the distance between the first plate terminal end portion 612b and the second plate terminal end portion 711b is preferably 50% or less, more preferably 30% or less, still more preferably 10% or less with respect to the length of the first electrode assembly body portion 610 or the second electrode assembly body portion 710 in the X-axis direction.

In the present embodiment, the first plate terminal end portion 612b and the second plate terminal end portion 711b are not disposed at positions which do not overlap each other beyond the respective terminal end portions, but are disposed at positions which do not overlap each other by being disposed in front of the respective terminal end portions. That is, the first plate terminal end portion 612b is not disposed at a position which does not overlap the second plate terminal end portion 711b beyond the second plate terminal end portion 711b in the X-axis direction, but is disposed at a position which does not overlap the second plate terminal end portion 711b by being disposed in front of the second plate terminal end portion 711b. Similarly, the second plate terminal end portion 711b is not disposed at a position which does not overlap the first plate terminal end portion 612b beyond the first plate terminal end portion 612b in the X-axis direction, but is disposed at a position which does not overlap the first plate terminal end portion 612b by being positioned in front of the first plate terminal end portion 612b.

The first plate start end portion 612a of the first electrode assembly 600 and the second plate start end portion 711a of the second electrode assembly 700 are disposed so as to face each other with their distal ends facing each other in the X-axis direction as viewed in the Y-axis direction. That is, the first plate start end portion 612a and the second plate start end portion 711a protrude in directions facing each other and are disposed at positions which do not overlap each other as viewed in the arrangement direction of the first electrode assembly 600 and the second electrode assembly 700 (Y-axis direction). In the present embodiment, the first plate start end portion 612a and the second plate start end portion 711a are disposed at intervals in the X-axis direction as viewed in the Y-axis direction, but may be disposed so as not to be spaced apart from each other in the X-axis direction. Similarly, the first plate start end portion 612a and the first plate terminal end portion 612b are disposed at intervals in the X-axis direction as viewed in the Y-axis direction, but may be disposed so as not to be spaced apart from each other in the X-axis direction. The second plate start end portion 711a and the second plate terminal end portion 711b are disposed at intervals in the X-axis direction as viewed in the Y-axis direction, but may be disposed so as not to be spaced apart from each other in the X-axis direction.

Specifically, the distance between the first plate start end portion 612a and the second plate start end portion 711a is preferably 50% or less, more preferably 30% or less, still more preferably 10% or less with respect to the length of the first electrode assembly body portion 610 or the second electrode assembly body portion 710 in the X-axis direction. The same applies to the distance between the first plate start end portion 612a and the first plate terminal end portion 612b and the distance between the second plate start end portion 711a and the second plate terminal end portion 711b.

The configuration and positional relationship of the first separators 661 and 662 and the second separators 761 and 762 are not particularly limited, but can be the same as those of the second plate 750 (or 740) and the second plate 750 (or 740).

As described above, the first plate start end portion 612a and the first plate terminal end portion 612b are disposed on the first electrode assembly flat portion 612 which faces the second electrode assembly 700, and the first positive electrode tab 620 and the first negative electrode tab 630 are disposed on the first electrode assembly flat portion 611 disposed on a side opposite to the second electrode assembly 700. The second plate start end portion 711a and the second plate terminal end portion 711b are disposed on the second electrode assembly flat portion 711 which faces the first electrode assembly 600, and the second positive electrode tab 720 and the second negative electrode tab 730 are disposed on the second electrode assembly flat portion 712 disposed on a side opposite to the first electrode assembly 600.

That is, at least one tab of the first positive electrode tab 620 and the first negative electrode tab 630 is disposed so as to protrude from a part of a portion (first electrode assembly flat portion 611) of the first electrode assembly body portion 610 on a side opposite to the second electrode assembly body portion 710 with respect to a portion (first electrode assembly flat portion 612) of the first electrode assembly body portion 610 which faces the second electrode assembly body portion 710. Out of the second positive electrode tab 720 and the second negative electrode tab 730, a tab having the same polarity as a polarity of the at least one tab of the first positive electrode tab 620 and the first negative electrode tab 630 is disposed so as to protrude from a part of a portion (second electrode assembly flat portion 712) of the second electrode assembly body portion 710 on a side opposite to the first electrode assembly body portion 610 with respect to a portion (second electrode assembly flat portion 711) of the second electrode assembly body portion 710 facing the first electrode assembly body portion 610. In the present embodiment, both the first positive electrode tab 620 and the first negative electrode tab 630 are disposed so as to protrude from a part of the first electrode assembly flat portion 611 on a side opposite to the second electrode assembly body portion 710 in the first electrode assembly body portion 610. Both the second positive electrode tab 720 and the second negative electrode tab 730 are disposed so as to protrude from a part of the second electrode assembly flat portion 712 on a side opposite to the first electrode assembly body portion 610 in the second electrode assembly body portion 710.

The first positive electrode tab 620 is disposed at an end portion of the first electrode assembly flat portion 611 in the X-axis negative direction, and the first negative electrode tab 630 is disposed at an end portion of the first electrode assembly flat portion 611 in the X-axis positive direction. The second positive electrode tab 720 is disposed at an end portion of the second electrode assembly flat portion 712 in the X-axis negative direction, and the second negative electrode tab 730 is disposed at an end portion of the second electrode assembly flat portion 712 in the X-axis positive direction. With this configuration, the direction from the first positive electrode tab 620 toward the first negative electrode tab 630 and the direction from the second positive electrode tab 720 toward the second negative electrode tab 730 are the same direction. That is, both the direction from the first positive electrode tab 620 toward the first negative electrode tab 630 and the direction from the second positive electrode tab 720 toward the second negative electrode tab 730 are not only the direction parallel to the X-axis direction, but also the same direction (in the present embodiment, X-axis positive direction) as one direction in the X-axis direction.

In other words, the first positive electrode tab 620 and the second positive electrode tab 720 are disposed in the same direction (X-axis negative direction) with respect to the first negative electrode tab 630 and the second negative electrode tab 730. That is, the first positive electrode tab 620 and the second positive electrode tab 720 are disposed on the same side with respect to the center position of the first electrode assembly 600 and the center position of the second electrode assembly 700 in the X-axis direction. The first negative electrode tab 630 and the second negative electrode tab 730 are disposed on a side opposite to the first positive electrode tab 620 and the second positive electrode tab 720 with respect to the center position of the first electrode assembly 600 and the center position of the second electrode assembly 700 in the X-axis direction. Specifically, the first positive electrode tab 620 and the second positive electrode tab 720 are disposed at positions which overlap each other as viewed in the Y-axis direction, and the first negative electrode tab 630 and the second negative electrode tab 730 are disposed at positions which overlap each other as viewed in the Y-axis direction. In the present embodiment, the first positive electrode tab 620 and the second positive electrode tab 720 are disposed at the same position in the X-axis direction, and the first negative electrode tab 630 and the second negative electrode tab 730 are disposed at the same position in the X-axis direction.

### [4 Description of Effects]

As described above, according to the energy storage device 10 of the embodiment of the present invention, the first electrode assembly 600 formed by winding the first plates 640 and 650 includes the first electrode assembly body portion 610, the first positive electrode tab 620, and the first negative electrode tab 630. The second electrode assembly 700 formed by winding the second plates 740 and 750 includes the second electrode assembly body portion 710, the second positive electrode tab 720, and the second negative electrode tab 730. The first plate terminal end portion 612b of the first electrode assembly body portion 610 which faces the second electrode assembly body portion 710 and the second plate terminal end portion 711b of the second electrode assembly body portion 710 which faces the first electrode assembly body portion 610 are disposed at positions which do not overlap each other. In this manner, the first plate terminal end portion 612b of the first electrode assembly body portion 610 is disposed at a position facing the second electrode assembly body portion 710, and the second plate terminal end portion 711b of the second electrode assembly body portion 710 is disposed at a position facing the first electrode assembly body portion 610 and at a position which does not overlap the first plate terminal end portion 612b. With such a configuration, it is possible to suppress generation of an unnecessary space between the first electrode assembly 600 and the second electrode assembly 700 (between the first electrode assembly body portion 610 and the second electrode assembly body portion 710) and hence, the energy storage device 10 can be reduced in size or increased in capacity. However, the disposition of the first plate terminal end portion 612b and the second plate terminal end portion 711b at positions which do not overlap each other does not mean that the first plate terminal end portion 612b and the second plate terminal end portion 711b are disposed at positions which do not overlap each other beyond the respective terminal end portions.

That is, when the first plate terminal end portion 612b of the first electrode assembly body portion 610 is disposed to face the inner surface of the second electrode assembly body portion 710 or the case 100, an unnecessary space is generated between a portion of the first electrode assembly body portion 610 where the first plate terminal end portion 612b is not disposed and the inner surface of the second electrode assembly body portion 710 or the case 100. Accordingly, the first plate terminal end portion 612b faces the second electrode assembly body portion 710, and the second plate terminal end portion 711b faces the first electrode assembly body portion 610 and is disposed at a position which does not overlap the first plate terminal end portion 612b. With such a configuration, the second plate terminal end portion 711b can be disposed on a portion of the first electrode assembly body portion 610 where the first plate terminal end portion 612b is not disposed and hence, it is possible to suppress generation of the above-mentioned unnecessary space, whereby the energy storage device 10 can be reduced in size or increased in capacity.

When the first plate terminal end portion 612b and the second plate terminal end portion 711b are disposed so as not to be spaced apart from each other in the X-axis direction as viewed in the Y-axis direction, lengths of the plates can be made longer than when the first plate terminal end portion 612b and the second plate terminal end portion 711b are disposed so as to be spaced apart from each other. In this case, a space between the first electrode assembly 600 and the second electrode assembly 700 can be effectively utilized, and the energy storage device 10 can be further reduced in size or increased in capacity.

The configuration in which the first plate terminal end portion 612b of the first electrode assembly 600 is disposed at a position facing the second electrode assembly body portion 710 and the second plate terminal end portion 711b of the second electrode assembly 700 is disposed at a position facing the first electrode assembly body portion 610 can be realized by rotating one of the two same electrode assemblies by 180°. The above-mentioned configuration can be realized by defining the electrode assembly obtained by rotating the first electrode assembly 600 by 180° as the second electrode assembly 700 and defining the first plate terminal end portion 612b of the first electrode assembly 600 rotated by 180° as the second plate terminal end portion 711b. However, in this case, the first positive electrode tab 620 and the second positive electrode tab 720 are disposed in opposite directions with respect to the first negative electrode tab 630 and the second negative electrode tab 730, and it becomes difficult to connect tabs having the same polarity to one current collector 500. Therefore, even when the first plate terminal end portion 612b and the second plate terminal end portion 711b are disposed as described above, the direction from the first positive electrode tab 620 toward the first negative electrode tab 630 and the direction from the second positive electrode tab 720 toward the second negative electrode tab 730 are disposed in the same direction. Accordingly, since the first positive electrode tab 620 and the second positive electrode tab 720 are disposed in the same direction with respect to the first negative electrode tab 630 and the second negative electrode tab 730, the tabs having the same polarity can be easily connected to one current collector 500.

The configuration in which the first plate terminal end portion 612b of the first electrode assembly 600 is disposed at a position facing the second electrode assembly body portion 710 and the second plate terminal end portion 711b of the second electrode assembly 700 is disposed at a position facing the first electrode assembly body portion 610 can be realized by disposing the two same electrode assemblies in the same direction and adjusting the lengths of the plates. The above-mentioned configuration can be realized by adjusting the lengths of the first plates 640 and 650 of the first electrode assembly 600 to the same lengths as the lengths of the second plates 740 and 750 without rotating the first electrode assembly 600 and defining the first electrode assembly 600 as the second electrode assembly 700. This configuration can be realized by arranging two electrode assemblies in which plates are wound in the same direction from the same winding start position, directions from the positive electrode tabs to the negative electrode tabs are the same direction (arrangement positions of the positive electrode tabs and the negative electrode tabs are the same), and lengths of the plates are different by adjusting lengths of the plates (winding end positions of the plates). With such a configuration, it is possible to easily suppress generation of an unnecessary space between the first electrode assembly 600 and the second electrode assembly 700 (between the first electrode assembly body portion 610 and the second electrode assembly body portion 710) and hence, the energy storage device 10 can be easily reduced in size or increased in capacity.

However, in this case, the tab of one of the first electrode assembly 600 and the second electrode assembly 700 is disposed at a portion facing the other electrode assembly. That is, when the first electrode assembly 600 is defined as the second electrode assembly 700 without being rotated, since the first positive electrode tab 620 and the first negative electrode tab 630 protrude from the first electrode assembly flat portion 611, the second positive electrode tab 720 and the second negative electrode tab 730 protrude from the second electrode assembly flat portion 711. As a result, the distance between the tabs having the same polarity of the first electrode assembly 600 and the second electrode assembly 700 becomes short, and the tabs are densely disposed, so that an unnecessary space may be generated or it may be difficult to connect the tabs to the current collector 500. Accordingly, at least one tab of the first electrode assembly 600 is disposed so as to protrude from a portion of the first electrode assembly body portion 610 on a side opposite to the second electrode assembly body portion 710, and the tab having the same polarity as a polarity of the at least one tab, the tab out of the second electrode assembly 700 is disposed so as to protrude from a portion of the second electrode assembly body portion 710 on a side opposite to the first electrode assembly body portion 610. That is, the tabs having the same polarity of the first electrode assembly 600 and the second electrode assembly 700 are disposed on the sides opposite to the portions facing the electrode assembly body portions. With such a configuration, the tabs having the same polarity of the first electrode assembly 600 and the second electrode assembly 700 are disposed at positions spaced apart from each other and hence, it is possible to suppress generation of an unnecessary space due to dispersion of the tabs, and it is possible to make it easy to bend the tabs, whereby the tabs can be easily connected to the current collector 500.

At least one of the first plate terminal end portion 612b and the second plate terminal end portion 711b is disposed on a flat portion of at least one of the first electrode assembly body portion 610 and the second electrode assembly body portion 710. With such a configuration, a fixing position of the plate terminal end portion of the electrode assembly can be formed into a flat portion and hence, in the electrode assembly, the plate terminal end portion can be easily fixed with a tape or the like. In the present embodiment, flat portions (the first electrode assembly flat portion 612 and the second electrode assembly flat portion 711) are formed on both the first electrode assembly body portion 610 and the second electrode assembly body portion 710. Accordingly, the plate terminal end portion can be sandwiched between the flat portions (the first electrode assembly flat portion 612 and the second electrode assembly flat portion 711) of both the first electrode assembly body portion 610 and the second electrode assembly body portion 710 and hence, the plate terminal end portion can be easily fixed.

Both the first plate terminal end portion 612b and the second plate terminal end portion 711b are disposed so as to extend toward each other in the first electrode assembly body portion 610 and the second electrode assembly body portion 710, whereby the entire lengths of the first plates 640 and 650 and the second plates 740 and 750 can be increased. With such a configuration, a space between the first electrode assembly 600 and the second electrode assembly 700 can be effectively utilized and hence, the first electrode assembly 600 and the second electrode assembly 700 can be increased in capacity, whereby the energy storage device 10 can be easily reduced in size or increased in capacity. Specifically, the distance between the first plate terminal end portion 612b and the second plate terminal end portion 711b is preferably 50% or less, more preferably 30% or less, still more preferably 10% or less with respect to the length of the first electrode assembly body portion 610 or the second electrode assembly body portion 710 in the X-axis direction. As the distance between the first plate terminal end portion 612b and the second plate terminal end portion 711b becomes shorter, the space between the first electrode assembly 600 and the second electrode assembly 700 can be more effectively utilized, and the first electrode assembly 600 and the second electrode assembly 700 can be further increased in capacity.

The first plate start end portion 612a of the first electrode assembly body portion 610 and the second plate start end portion 711a of the second electrode assembly body portion 710 are disposed at positions which do not overlap each other as viewed in the arrangement direction of the first electrode assembly 600 and the second electrode assembly 700 (Y-axis direction). With such a configuration, an overlap between the first plate 650 (or 640) and the second plate 750 (or 740) can be reduced and hence, the energy storage device 10 can be reduced in size or increased in capacity.

The above-mentioned configuration can be applied to both the first plates 640 and 650. However, since the first plate 650 on the negative electrode side is disposed on the innermost circumference (innermost layer) and the outermost circumference (outermost layer) of the first plates 640 and 650, the above-mentioned effect can be enhanced by applying the configuration to the first plate 650 rather than applying the configuration to the first plate 640. The above-mentioned effect can be enhanced by applying the configuration to both the first plates 640 and 650 rather than to one of the first plates 640 and 650. Since the first separators 661 and 662 are thin, high effects cannot be obtained, but the above-mentioned effect can be obtained by employing the same configuration as that of the first plate 650 (or 640). The same applies to the second plates 740 and 750 and the second separators 761 and 762.

### [5 Description of Modifications]

Although the energy storage device 10 according to the embodiment of the present invention has been described above, the present invention is not limited to this embodiment. The embodiment disclosed herein is an example in all respects, and the scope of the present invention includes meanings equivalent to the claims and all modifications within the scope.

In the above-mentioned embodiment, the arrangement positions of the tabs (the first positive electrode tab 620 and the first negative electrode tab 630, and the second positive electrode tab 720 and the second negative electrode tab 730) of the first electrode assembly 600 and the second electrode assembly 700 are not particularly limited. Specifically, it is as follows.

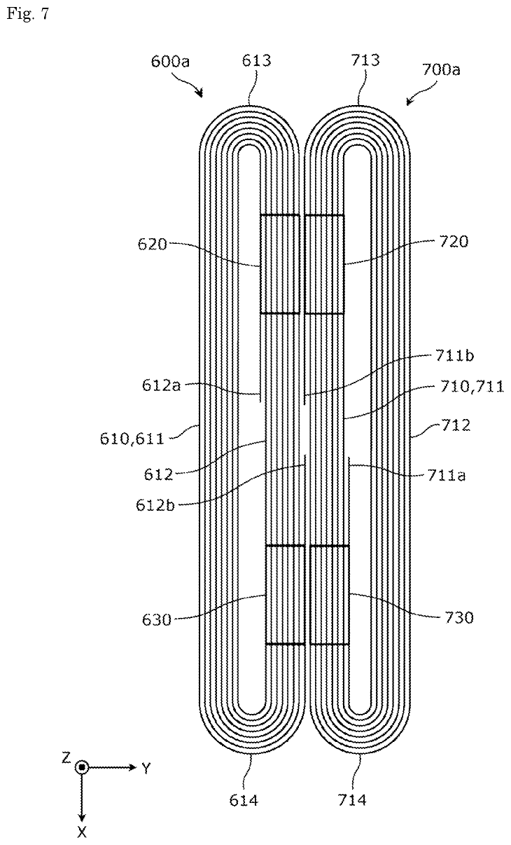

In the above-mentioned embodiment, at least one of the first positive electrode tab 620 and the first negative electrode tab 630 may be disposed so as to protrude from the first electrode assembly flat portion 612, or at least one of the second positive electrode tab 720 and the second negative electrode tab 730 may be disposed so as to protrude from the second electrode assembly flat portion 711. That is, as shown in FIG. 7, the first positive electrode tab 620 and the first negative electrode tab 630 may be disposed so as to protrude from a part of a portion (first electrode assembly flat portion 612) of the first electrode assembly body portion 610 which faces the second electrode assembly body portion 710. The second positive electrode tab 720 and the second negative electrode tab 730 may be disposed so as to protrude from a part of a portion (second electrode assembly flat portion 711) of the second electrode assembly body portion 710 which faces the first electrode assembly body portion 610. FIG. 7 is a top view showing an example of arrangement positions of tabs of a first electrode assembly 600a and a second electrode assembly 700a according to Modification 1 of the present embodiment. Specifically, FIG. 7 is a view corresponding to FIG. 6. In a case where the first positive electrode tab 620 and the second positive electrode tab 720 are easily joined to the current collector 500 when bundled, the configuration of the present modification is preferable.

In the above-mentioned embodiment, the direction from the first positive electrode tab 620 toward the first negative electrode tab 630 and the direction from the second positive electrode tab 720 toward the second negative electrode tab 730 may be different directions. The first positive electrode tab 620 and the first negative electrode tab 630 may be disposed at opposite positions, or the second positive electrode tab 720 and the second negative electrode tab 730 may be disposed at opposite positions.

In the above-mentioned embodiment, the first positive electrode tab 620 and the second positive electrode tab 720 may be disposed out of position in the X-axis direction so as not to overlap each other as viewed in the Y-axis direction. The same applies to the first negative electrode tab 630 and the second negative electrode tab 730. As described above, the arrangement positions of the tabs of the first electrode assembly 600 and the second electrode assembly 700 are not particularly limited, and various forms are possible.

In the above-mentioned embodiment, the first plate start end portion 612a and the first plate terminal end portion 612b of the first electrode assembly 600 are disposed at the middle portion of the first electrode assembly flat portion 612 in the X-axis direction, and the second plate start end portion 711a and the second plate terminal end portion 711b of the second electrode assembly 700 are disposed at the middle portion of the second electrode assembly flat portion 711 in the X-axis direction. However, the following forms may be adopted.

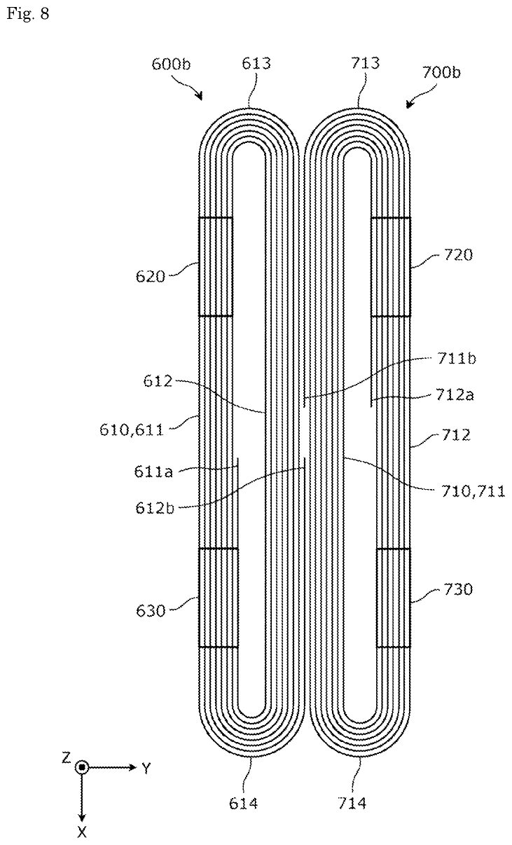

In the above-mentioned embodiment, the first plate start end portion may be disposed on the first electrode assembly flat portion 611, or the second plate start end portion may be disposed on the second electrode assembly flat portion 712. FIG. 8 is a top view showing an example of arrangement positions of plate start end portions of a first electrode assembly 600b and a second electrode assembly 700b according to Modification 2 of the present embodiment. Specifically, FIG. 8 is a view corresponding to FIG. 6. As shown in FIG. 8, a first plate start end portion 611a is disposed at the middle portion of the first electrode assembly flat portion 611 in the X-axis direction, and a second plate start end portion 712a is disposed at the middle portion of the second electrode assembly flat portion 712 in the X-axis direction. The first plate start end portion 611a and the second plate start end portion 712a protrude in directions facing each other and are disposed at positions which do not overlap each other as viewed in the arrangement direction of the first electrode assembly 600b and the second electrode assembly 700b (Y-axis direction).

In the above-mentioned embodiment, the first plate start end portion 612a may be disposed at an end portion of the first electrode assembly flat portion 612 in the X-axis direction, and the second plate start end portion 711a may be disposed at an end portion of the second electrode assembly flat portion 711 in the X-axis direction. The first plate start end portion 612a may be disposed at an end portion of the first electrode assembly flat portion 612 in the X-axis negative direction, and the second plate start end portion 711a may be disposed at an end portion of the second electrode assembly flat portion 711 in the X-axis negative direction or an end portion of the second electrode assembly flat portion 711 in the X-axis positive direction. The first plate start end portion 612a may be disposed on the first electrode assembly curved portion 613 or 614, and the second plate start end portion 711a may be disposed on the second electrode assembly curved portion 713 or 714. The first plate start end portion 612a may be disposed on the first electrode assembly curved portion 613, and the second plate start end portion 711a may be disposed on the second electrode assembly curved portion 713 or 714. The same applies to the first plate start end portion 611a and the second plate start end portion 712a shown in FIG. 8.

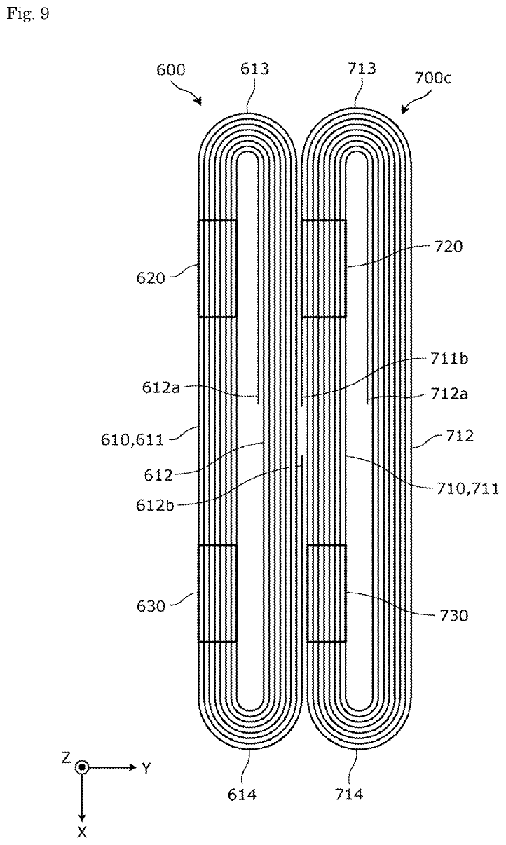

In the above-mentioned embodiment, the first plate start end portion 612a and the second plate start end portion 711a may be disposed at positions which overlap each other as viewed in the Y-axis direction. The first plate start end portion 612a and the second plate start end portion 711a may be disposed at any position in addition to the above aspect. The same applies to the first plate start end portion 611a and the second plate start end portion 712a shown in FIG. 8. FIG. 9 is a top view showing an example of arrangement positions of plate start end portions and tabs of the first electrode assembly 600 and a second electrode assembly 700c according to Modification 3 of the present embodiment. Specifically, FIG. 9 is a view corresponding to FIG. 6. As shown in FIG. 9, the first plate start end portion 612a and the second plate start end portion 712a are disposed at positions which overlap each other as viewed in the Y-axis direction. In the present modification, the second positive electrode tab 720 and the second negative electrode tab 730 are disposed so as to protrude from a part of a portion (second electrode assembly flat portion 711) of the second electrode assembly body portion 710 which faces the first electrode assembly body portion 610. That is, in the present modification, the second electrode assembly 700c is formed by extending a winding end portion of a plate of an electrode assembly having the same configuration as the first electrode assembly 600 to the position of the second electrode assembly flat portion 711. In other words, the first electrode assembly 600 and the second electrode assembly 700c are two electrode assemblies in which plates are wound in the same direction from the same winding start position, the positive electrode tabs and the negative electrode tabs are disposed at the same positions, and the winding end positions of the plates are made different (adjusted by making lengths of the plates different).

In the above-mentioned embodiment, the first plate terminal end portion 612b may be disposed at an end portion of the first electrode assembly flat portion 612 in the X-axis direction, and the second plate terminal end portion 711b may be disposed at an end portion of the second electrode assembly flat portion 711 in the X-axis direction. The first plate terminal end portion 612b may be disposed at an end portion of the first electrode assembly flat portion 612 in the X-axis positive direction, and the second plate terminal end portion 711b may be disposed at a position of the end portion of the second electrode assembly flat portion 711 in the X-axis positive direction which does not overlap the first plate terminal end portion 612b as viewed in the Y-axis direction or at an end portion of the second electrode assembly flat portion 711 in the X-axis negative direction. The same applies to a case where the first plate terminal end portion 612b is disposed at an end portion of the first electrode assembly flat portion 612 in the X-axis negative direction.

In the above-mentioned embodiment, the first plate terminal end portion 612b may be disposed on the first electrode assembly curved portion 613 or 614, and the second plate terminal end portion 711b may be disposed on the second electrode assembly curved portion 713 or 714. The first plate terminal end portion 612b may be disposed at a position of the first electrode assembly curved portion 614 which faces the second electrode assembly curved portion 714. In this case, the second plate terminal end portion 711b may be disposed at a position of the second electrode assembly curved portion 714 which faces the first electrode assembly curved portion 614 and at a position which does not overlap the first plate terminal end portion 612b as viewed in the Y-axis direction, or may be disposed at a position of the second electrode assembly curved portion 713 which faces the first electrode assembly curved portion 613. The same applies to the case where the first plate terminal end portion 612b is disposed on the first electrode assembly curved portion 613.

In the above-mentioned embodiment, both the first plates 640 and 650 have the above-mentioned configuration, but either one of the first plates 640 and 650 may not have the above-mentioned configuration. However, as described above, since the first plate 650 on the negative electrode side is disposed on the innermost circumference (innermost layer) and the outermost circumference (outermost layer) of the first plates 640 and 650, the effect can be enhanced by applying the configuration to the first plate 650 rather than applying the configuration to the first plate 640. For this reason, the first plate 650 preferably has the above-mentioned configuration. Both the first plates 640 and 650 more preferably have the above-mentioned configuration. The same applies to the second plates 740 and 750.

In the above-mentioned embodiment, the numbers of windings (the numbers of layers which are layered) of the plates of the first electrode assembly 600 and the second electrode assembly 700 are not particularly limited, and the numbers of windings (the numbers of layers which are layered) of the plates of the first electrode assembly 600 and the second electrode assembly 700 may be the same or different. Various configurations described above can be realized by adjusting the numbers of windings of the first electrode assembly 600 and the second electrode assembly 700 and adjusting the lengths of the plates of the first electrode assembly 600 and the second electrode assembly 700.

In the above-mentioned embodiment, the first electrode assembly 600 and the second electrode assembly 700 have an oval shape as viewed in the Z-axis direction, but at least one of the first electrode assembly 600 and the second electrode assembly 700 may have an elliptical shape, a circular shape, or the like as viewed in the Z-axis direction, and the shape thereof is not particularly limited. That is, at least one of the first electrode assembly body portion 610 and the second electrode assembly body portion 710 may not include the flat portion. In the electrode assembly having no flat portion, the plate start end portion and the plate terminal end portion are disposed on the curved portion.

In the above-mentioned embodiment, the first electrode assembly 600 and the second electrode assembly 700 are so-called laterally wound electrode assemblies whose winding axes are perpendicular to the lid body 120, but may be so-called vertically wound electrode assemblies whose winding axes are parallel to the lid body 120. Even in this case, a configuration similar to that of the above-mentioned embodiment can be realized by forming tabs on the vertically wound electrode assemblies.

A form constructed by freely combining the above-mentioned embodiment and the above modifications is also included in the scope of the present invention.

The present invention can be realized not only as such an energy storage device but also as a combination of the first electrode assembly and the second electrode assembly.

### INDUSTRIAL APPLICABILITY

The present invention can be applied to an energy storage device such as a lithium ion secondary battery.

### DESCRIPTION OF REFERENCE SIGNS

10: energy storage device
100: case
110: case body
120: lid body
200: electrode terminal
300: upper gasket
400: lower gasket
500: current collector
600, 600a, 600b: first electrode assembly
610: first electrode assembly body portion
611, 612: first electrode assembly flat portion
611a, 612a: first plate start end portion
612b: first plate terminal end portion
613, 614: first electrode assembly curved portion
620: first positive electrode tab
630: first negative electrode tab
640, 650: first plate
641, 651, 741, 751: tab
661, 662: first separator
700, 700a, 700b, 700c: second electrode assembly
710: second electrode assembly body portion
711, 712: second electrode assembly flat portion
711a, 712a: second plate start end portion
711b: second plate terminal end portion
713, 714: second electrode assembly curved portion
720: second positive electrode tab
730: second negative electrode tab
740, 750: second plate
761, 762: second separator

1. An energy storage device comprising:
a first electrode assembly formed by winding a first plate; and
a second electrode assembly formed by winding a second plate,
wherein the first electrode assembly includes:
a first electrode assembly body portion; and
a first positive electrode tab and a first negative electrode tab which are tabs protruding from a part of the first electrode assembly body portion and disposed on a positive electrode side and a negative electrode side,
the second electrode assembly includes:
a second electrode assembly body portion; and
a second positive electrode tab and a second negative electrode tab which are tabs protruding from a part of the second electrode assembly body portion and disposed on a positive electrode side and a negative electrode side,
the first electrode assembly body portion includes a first plate terminal end portion which is a winding end portion of the first plate at a position facing the second electrode assembly body portion,
the second electrode assembly body portion includes a second plate terminal end portion which is a winding end portion of the second plate at a position facing the first electrode assembly body portion, and
the first plate terminal end portion and the second plate terminal end portion are disposed at positions which do not overlap each other as viewed in an arrangement direction of the first electrode assembly and the second electrode assembly.

2. The energy storage device according to claim 1, wherein a direction from the first positive electrode tab toward the first negative electrode tab and a direction from the second positive electrode tab toward the second negative electrode tab are the same direction.

3. The energy storage device according to claim 2, wherein
at least one tab of the first positive electrode tab and the first negative electrode tab is disposed so as to protrude from a part of a portion of the first electrode assembly body portion, the portion being on a side opposite to the second electrode assembly body portion with respect to a portion facing the second electrode assembly body portion, and
a tab out of the second positive electrode tab and the second negative electrode tab, the tab having the same polarity as a polarity of the at least one tab is disposed so as to protrude from a part of a portion of the second electrode assembly body portion, the portion being on a side opposite to the first electrode assembly body portion with respect to a portion facing the first electrode assembly body portion.

4. The energy storage device according to claim 1, wherein
at least one of the first electrode assembly body portion and the second electrode assembly body portion includes:
a pair of curved portions formed by winding at least one of the first plate and the second plate; and
a flat portion which connects the pair of curved portions, and
at least one of the first plate terminal end portion and the second plate terminal end portion is disposed on the flat portion.

5. The energy storage device according to claim 1, wherein
the first plate terminal end portion extends toward the second plate terminal end portion at a portion of the first electrode assembly body portion, the portion facing the second electrode assembly body portion, and
the second plate terminal end portion extends toward the first plate terminal end portion at a portion of the second electrode assembly body portion, the portion facing the first electrode assembly body portion.
